(19) United States
(12) Patent Application Publication
(10) Pub. No.: US 2025/0082542 A1
(43) Pub. Date: Mar. 13, 2025

(54) LIGHTING FOR MECHANICAL CPR DEVICE

(71) Applicant: PHYSIO-CONTROL, INC., Redmond, WA (US)

(72) Inventors: Marcus Ehrstedt, Kävlinge (SE); Jonas Lagerström, Fagersanna (SE); Sara Lindroth, Lund (SE); Maria Rojas Garcia, Mälmo (SE); William Widlund, Lund (SE); Per Axelsson, Åkarp (SE); Johan Nordström, Helsingborg (SE); Erik von Schenck, Lomma (SE); Dennis Changmin Sohn, Seattle, WA (US)

(73) Assignee: PHYSIO-CONTROL, INC., Redmond, WA (US)

(21) Appl. No.: 18/882,614

(22) Filed: Sep. 11, 2024

Related U.S. Application Data
(60) Provisional application No. 63/538,017, filed on Sep. 12, 2023.

(51) Int. Cl. A61H 31/00

(52) U.S. Cl. CPC A61H 31/006; A61H 31/008; A61H 2031/001; A61H 2201/0188; A61H 2203/0456; A61H 2205/084

(57) ABSTRACT

A mechanical cardiopulmonary resuscitation (“CPR”) device includes a compression mechanism, a support structure, and a light source. The compression mechanism is configured to perform successive CPR compressions to a chest of a patient and includes, in one example configuration, a translucent suction cup, a piston, and a driver coupled to the piston and configured to extend the piston toward the chest of the patient and retract the piston away from the chest of the patient. The support structure is configured to position the compression mechanism over the chest of the patient. The light source is configured to illuminate the translucent suction cup.

### CROSS-REFERENCES TO RELATED APPLICATIONS

This patent application claims the benefit of provisional Application No. 63/538,017, filed Sep. 12, 2023. Application No. 63/538,017 is incorporated into the present disclosure by this reference.

### TECHNICAL FIELD

The subject matter is related to systems and methods that can be applied to mechanical cardiopulmonary resuscitation (CPR) devices.

### BACKGROUND

In certain types of medical emergencies a patient's heart stops working. This stops the blood flow, without which the patient may die. CPR can forestall the risk of death. CPR includes performing repeated chest compressions to the chest of the patient to cause their blood to circulate. CPR can also include delivering rescue breaths to the patient. CPR is intended to merely maintain the patient until a more definite therapy is made available, such as defibrillation.

Mechanical compression devices for CPR are being increasingly adopted by emergency medical services around the world. Traditionally, CPR has been performed manually by a rescuer. However, during longer duration resuscitations, a rescuer can become fatigued and provide inadequate compressions. Mechanical compression devices have been adopted by many emergency medical services to address these potential drawbacks of manual CPR by a rescuer.

The correct positioning of a mechanical CPR device relative to a patient's chest is critical to provide effective chest compressions. However, during an emergency situation or with first time or rare rescuers, it can be difficult to correctly align the mechanical CPR device to the patient. During the time the mechanical CPR device is being aligned, a patient might not be receiving chest compressions. As a result, the longer it takes to align the mechanical CPR device, the more detrimental it can be to the patient.

It is also important to effective use of the mechanical CPR device for the rescuer to be able to properly see the patient and the mechanical CPR device in a dark environment and for the rescuer to receive warnings, alerts, and other information from the mechanical CPR device.

Configurations of the disclosed technology address shortcomings in the prior art.

### BRIEF DESCRIPTION OF THE DRAWINGS

FIG. 1 is a perspective view of an example mechanical CPR device.

FIG. 2 is a front view of the mechanical CPR device of FIG. 1, showing an example configuration having a bellows with a translucent portion and a non-translucent portion.

FIG. 3 is a front view of a portion of the mechanical CPR device of FIG. 2, showing the bellows in section view.

FIG. 4 is a front view of a portion of the mechanical CPR device of FIG. 2, showing the bellows in section view.

FIG. 5 illustrates an example method of adjusting light intensity based on a photocell signal.

FIG. 6 is a front view of a portion of the mechanical CPR device of FIG. 2, showing an example configuration having dynamic light sources.

FIG. 7 is a front view of the mechanical CPR device of FIG. 1, illustrating example locations for light sources.

FIGS. 8-13 illustrate examples of light patterns that may be produced in configurations of the disclosed technology.

FIG. 14 is a perspective view of the mechanical CPR device of FIG. 1, showing an additional example configuration having markings on a backboard.

### DETAILED DESCRIPTION

As described herein, aspects are directed to a methods of providing lighting for a mechanical CPR device, including lighting to aid the rescuer to properly see the patient and the mechanical CPR device in a dark environment, to aid the rescuer to properly position the patient relative the mechanical CPR device, and for the rescuer to receive warnings, alerts, and other information from the mechanical CPR device.

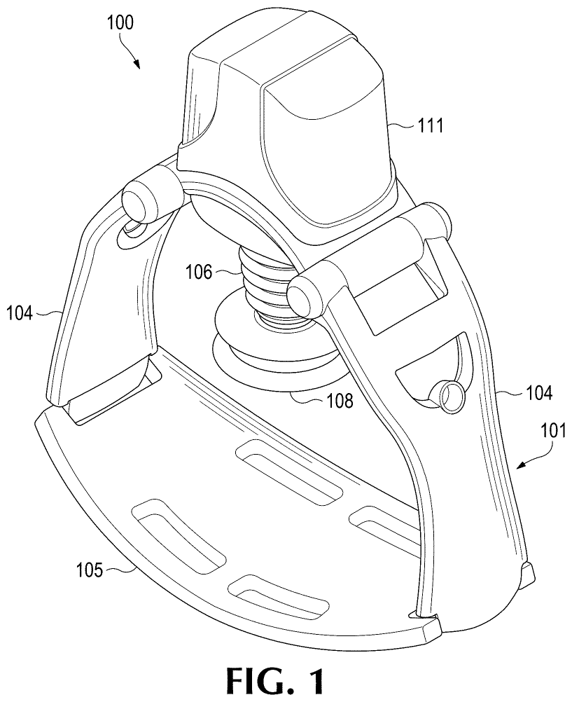

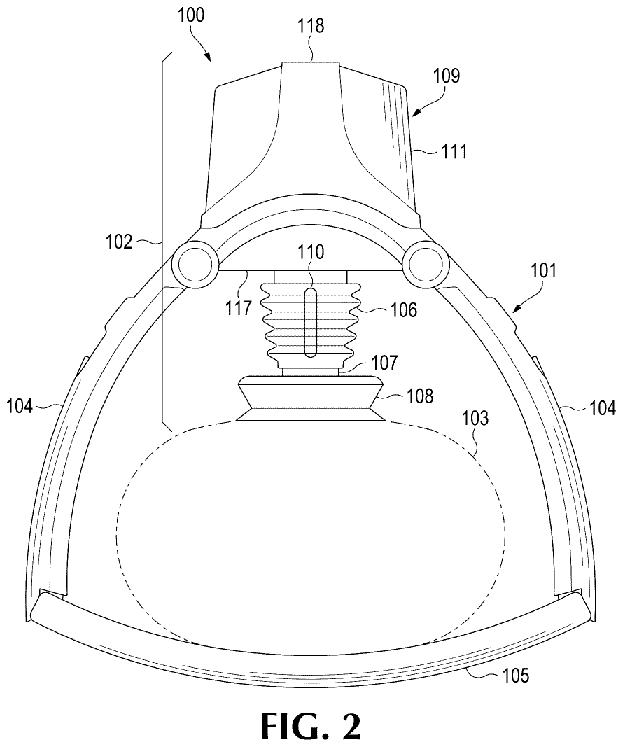

FIG. 1 is a perspective view of an example mechanical CPR device 100. FIG. 2 is a front view of the mechanical CPR device 100 of FIG. 1, according to an example configuration. As illustrated in FIGS. 1 and 2, a mechanical CPR device 100 may include a support structure 101 and a compression mechanism 102. The support structure 101 is configured to position the compression mechanism 102 over the chest of a patient 103. The support structure 101 may include one or more support legs 104 configured to support the chest compression mechanism 102 over the chest of the patient 103. In the illustrated configuration, the support structure 101 includes a backboard 105 configured to be placed underneath the patient 103 and two support legs 104 configured to support the chest compression mechanism 102 at a distance from the backboard 105. For example, if the backboard 105 is underneath the patient 103, contacting the patient's back, then the support legs 104 may support the compression mechanism 102 at a sufficient distance over the backboard 105 to allow the patient 103 to lay within a space between the backboard 105 and the compression mechanism 102, while positioning the compression mechanism 102 over the chest of the patient 103. The compression mechanism 102 is configured to perform successive CPR compressions to the chest of the patient 103. In the illustrated configuration, the compression mechanism 102 includes a bellows 106, a piston 107, a suction cup 108, and a driver 109.

The bellows 106 is configured to substantially surround the piston 107, whether the piston 107 is fully extended or fully retracted, to keep external debris away from the piston 107. As used in this disclosure, “substantially surround” means largely or essentially extending around, without requiring perfect encircling. In some configurations, however, a bellows 106 is not required. In configurations, the bellows 106 may be substantially translucent. As used in this disclosure, “substantially translucent” means largely or essentially either transparent or diffusing light that is transmitted through the substantially translucent item, without requiring perfect transparency or diffuse-ability of the entire substantially translucent item. Hence, for example, the bellows 106 could be formed from a material that is substantially translucent, such as silicone. Other materials could also be used.

In other configurations, a portion of the bellows 106 may be substantially translucent, while another portion of the bellows 106 is non-translucent. Hence, for example, FIG. 2 illustrates a window 110 in the bellows 106 that is substantially translucent while the remainder of the bellows 106 is non-translucent. In configurations, the translucent portion need not be as illustrated in FIG. 2. For example, the window 110 could be larger or smaller, have a different shape or orientation, or be in a different position on the bellows 106. In configurations, there could also be multiple windows 110. In configurations, the window 110 could be the location of the non-translucent portion while the remainder of the bellows 106 is substantially translucent. In this way, a desired pattern of light and shadow can be created based on the position and number of translucent and non-translucent portions of the bellows 106 as well as the location of the light sources 112. The translucent portion and the non-translucent portion could be made from, for example, different types of silicone, although other materials could be used, as well.

In configurations, particularly configurations where the light source 112 (as explained below) is configured to emit blacklight, the bellows 106—whether being substantially translucent, having a translucent portion and a non-translucent portion, or being non-translucent—may include a luminescent material configured to luminesce in the presence of blacklight, such as a fluorescent material. The luminescent material may be, as examples, painted onto the bellows 106 or adhered to the bellows 106 (i.e. as a sticker).

In the configuration illustrated in FIG. 1, the piston 107 extends through the interior of the bellows 106 (in configurations having a bellows 106) toward the chest of the patient 103.

As illustrated, the suction cup 108 may be attached to an end of the piston 107. The suction cup 108 is configured to adhere to the chest of the patient 103 to assist with compressions and lifting the chest of the patient 103, particularly for active decompression of the chest of the patient 103. In configurations, the suction cup 108 may be substantially translucent, non-translucent, or have a portion that is substantially translucent while another portion is non-translucent, as explained above for the bellows 106. In configurations, the suction cup 108 may include optical elements configured to block or redirect the light emitted by the light source 112 to produce a pattern of light on the support structure 101 or compression mechanism 102 that differs from what the pattern of light would be in the absence of such optical elements. Such optical elements may include, as examples, reflective materials, refractive materials, opaque materials, and relatively thicker sections of the wall of the suction cup 108 (such as through one or more reinforcement ribs). Similar to the bellows 106, in configurations, the suction cup 108—whether being substantially translucent, having a translucent portion and a non-translucent portion, or being non-translucent—may include a luminescent material configured to luminesce in the presence of blacklight, such as a fluorescent material.

The driver 109 is coupled to the piston 107 and is configured to extend the piston 107 toward the chest of the patient 103 and to retract the piston 107 away from the chest of the patient 103. In configurations, the driver 109 may be, as examples, an electric motor, a pneumatic motor, an electric actuator, a pneumatic actuator, a hydraulic actuator, or other mechanisms known for causing a piston 107 to reciprocate. Accordingly, the applicant intends to encompass within the meaning of “driver” any structure presently existing or developed in the future that performs the same function of causing a piston 107 to reciprocate toward the chest of a patient 103 and to retract away from the chest of the patient 103. As illustrated, the driver 109 is enclosed by a motor housing 111.

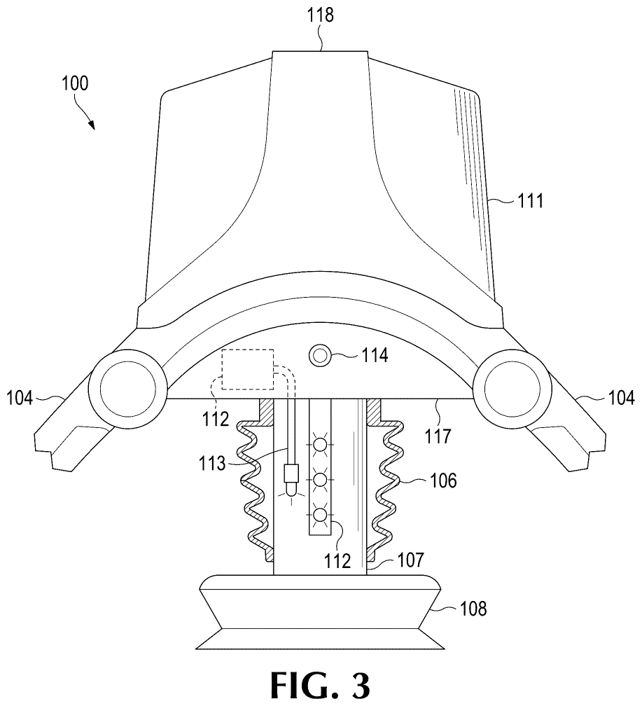

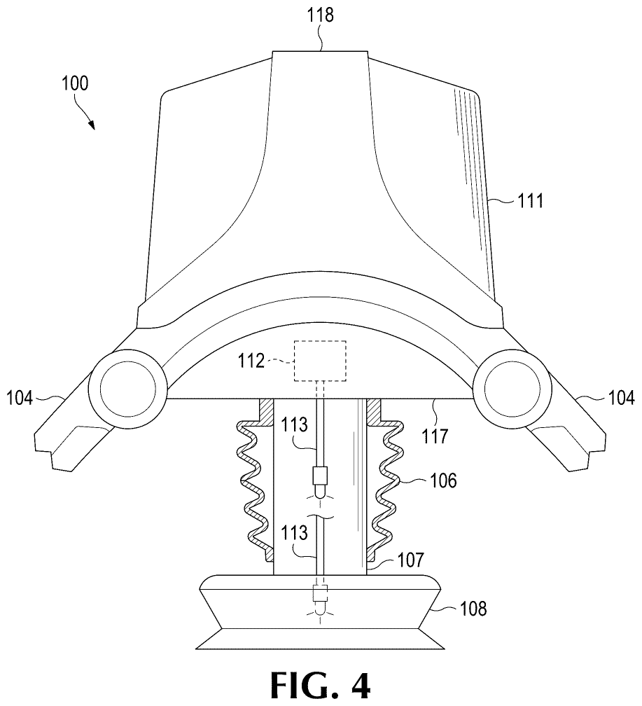

FIG. 3 is a front view of a portion of the mechanical CPR device 100 of FIG. 2, showing the bellows 106 in section view and also showing features from example configurations. FIG. 4 is a front view of a portion of the mechanical CPR device 100 of FIG. 2, showing the bellows 106 in section view and also showing features from other example configurations. The bellows 106 illustrated in FIGS. 3 and 4 may be substantially translucent, non-translucent, or have a portion that is substantially translucent while another portion is non-translucent. Even so, a bellows 106 that is either substantially translucent or that has a portion that is substantially translucent would work best for some of the features described here for FIG. 3. Likewise, the suction cup 108 illustrated in FIGS. 3 and 4 may be substantially translucent, non-translucent, or have a portion that is substantially translucent while another portion is non-translucent. Even so, a suction cup 108 that is either substantially translucent or that has a portion that is substantially translucent would work best for some of the features described here for FIG. 4.

As illustrated in FIGS. 3 and 4, the mechanical CPR device 100 may include a light source 112 configured to illuminate the interior of the translucent bellows 106. Accordingly, in configuration where the bellows 106 has a translucent portion and a non-translucent portion, the light source 112 is configured to illuminate the translucent portion and the non-translucent portion of the bellows 106. As a result, the light source 112 casts a light pattern that is determined, at least in part, by the translucent portion and the non-translucent portion of the bellows 106.

Hence, in configurations, the light source 112 is within the bellows 106. In other configurations, the mechanical CPR device 100 includes a fiberoptic conduit 113, such as shown in FIG. 4, that is configured to convey light emitted by the light source 112 to the interior of the bellows 106 or to a different location within the interior of the bellows 106. In configurations where light is emitted within or conveyed to the interior of the bellows 106, light shining through the substantially translucent bellows 106 may be seen from all angles by the user-rescuer and others that are nearby. This provides a beacon effect and also illuminates the area surrounding the mechanical CPR device 100. In a similar, though reduced, way, light shining through a translucent portion of the translucent bellows 106 may be seen by the user-rescuer and others that are nearby. And such light may also illuminate a portion of the area surrounding the mechanical CPR device 100.

In configurations, particularly configurations where the suction cup 108 is substantially translucent or has a portion that is substantially translucent, the fiberoptic conduit 113 may be configured to convey light emitted by the light source 112 to the interior of the suction cup 108 or to a different location within the interior of the suction cup 108, such as shown in FIG. 4. Additionally, particularly in configurations where the suction cup 108 is substantially translucent or has a portion that is substantially translucent, the light source 112 may be within the translucent suction cup 108 similar to what is discussed above for a light source 112 being within the translucent bellows 106.

In configurations, the light source 112 is on the support structure 101, external to the bellows 106 and the suction cup 108. In configurations where the light source 112 is on the support structure 101, the light source 112 may be integrated with the support structure 101, or the light source 112 may be joined to the support structure 101 by, for example, adhesive, fasteners, magnetic coupling, or an interference fit between a portion of the light source 112 and a portion of the support structure 101. In configurations, the light source 112 may be wirelessly coupled, or paired, to the support structure 101, and the light source 112 may be located, for example, on a mobile device, such as a smartphone. In configurations where the light source 112 is on the support structure 101, external to the bellows 106 and the suction cup 108, the light source 112 may be configured to cast a light pattern onto the backboard 105 or onto the patient 103 positioned on the backboard 105, whether by shining directly on the backboard 105 or the patient 103 or by shining through the bellows 106 and the suction cup 108 and onto the backboard 105 or the patient 103.

In configurations, the light source 112 is or includes one or more of a light-emitting diode (LED), a laser diode, an incandescent lamp, a fluorescent lamp, or another type of electric light.

In configurations, the light source 112 is configured to emit blacklight. In configurations, the light source 112 is configured to emit light of different colors or wavelengths at different times. Hence, for example, the light source 112 may emit green light at one time, then emit red light at another time, and then emit blacklight at still another time. In configurations, the light source 112 is configured to emit infrared radiation.

In configurations, the light source 112 is stroboscopic, meaning that the light source 112 is configured to produce pulses of light. In configurations, the pulsing maybe created by turning the light source 112 off and on. In such configurations, the period of time for each “off” segment and each “on” segment could vary depending on the pattern desired to be created. In configurations, the pulsing maybe created by gradually dimming and gradually increasing the intensity of the light source 112. Accordingly, the light emitted by the light source 112 may have an intensity that varies with time. In configurations, the light source 112 may pulse more quickly than the human eye can detect, such as at 60 Hertz or greater. In configurations, such pulsing, including pulsing in the infrared, may convey information to a receiver. The receiver could be coupled to, for example, another piece of medical equipment, such as a defibrillator.

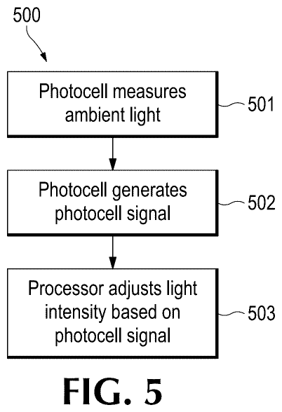

As illustrated in FIG. 3, in configurations the mechanical CPR device 100 includes a photocell 114 to measure an amount of ambient light. The photocell 114 is configured to generate a photocell signal based on a measured amount of ambient light. In such configurations, a processor in communication with the light source 112 and the photocell 114 is configured to adjust the intensity of light emitted by the light source 112 in response to the photocell signal. The processor may be, for example, within the motor housing 111 or elsewhere on or within the support structure 101. As illustrated in FIGS. 3 and 4, the processor is within the same structure that is identified as being the light source 112. FIG. 5 illustrates an example method 500 of adjusting the light intensity based on the photocell signal, the example method 500 having steps 501, 502, and 503 as illustrated. Hence, for example, where the photocell 114 determines that the amount of ambient light is relatively low, the light source 112 may be adjusted to either increase or decrease the intensity of light emitted by the light source 112. The intensity of the light may be increased, for example, to better illuminate the environment of the mechanical CPR device 100. The intensity of the light may be decreased, for example, to reduce energy consumption and save battery life where the light source 112 would be readily visible to the user even under low-light conditions.

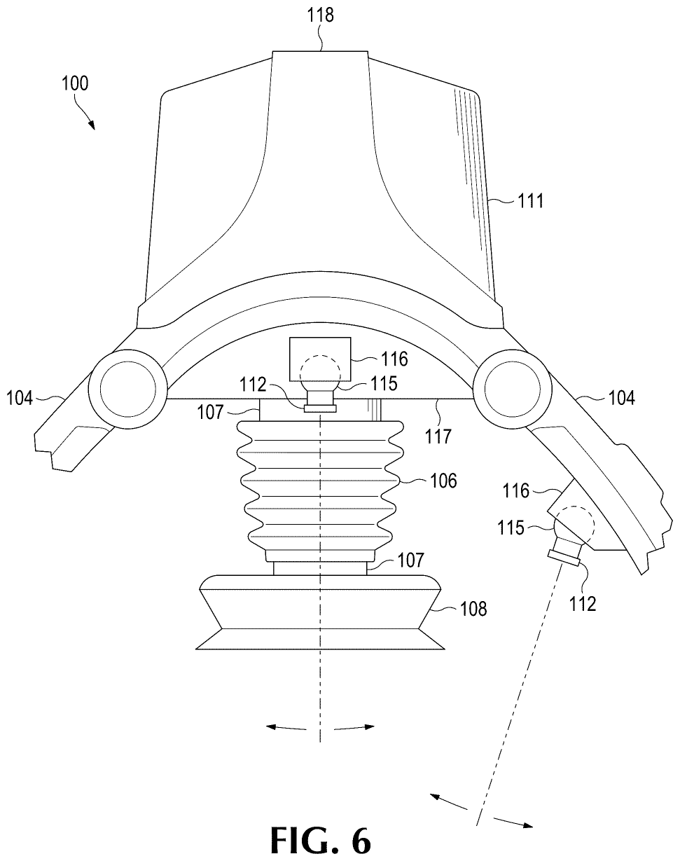

FIG. 6 is a front view of a portion of the mechanical CPR device 100 of FIG. 2, showing an example configuration having dynamic light sources 112. In addition to what is describe here for the dynamic light source 112 illustrated in FIG. 6, the dynamic light source 112 may have the same features and options as discussed above for the light source 112 illustrated in FIGS. 3 and 4. Thus, the same reference number is used. Also, while FIG. 6 illustrates examples of dynamic light sources 112, some of the discussion and features of FIG. 6 also apply to non-dynamic, fixed light sources 112.

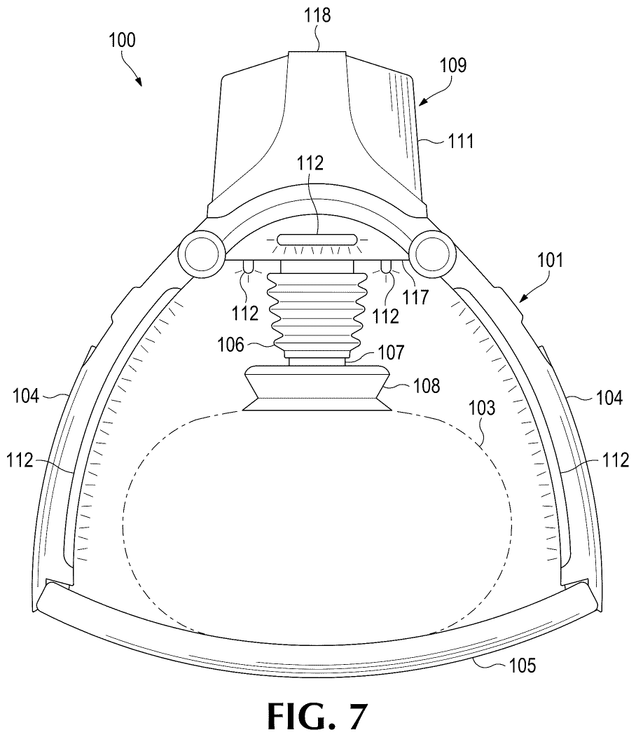

In configurations, the light source 112, whether it is a dynamic light source 112 or not, may be on one or more of the support leg 104, the backboard 105, or the motor housing 111. Also, while FIG. 6 shows the light sources 112 as being point sources, the light sources 112 could have other shapes and configurations, such as being rectangular, arcuate, or circular panels or being recessed within the support structure 101. In configurations, the panels may follow contours of the support structure 101 such as, for example, along one or more of the support legs 104. As other examples, a particular light source 112 may include multiple lightbulbs or LEDs in a pattern, such as a line or circle. In configurations, one or more light sources 112 may be mounted elsewhere on the motor housing 111, including a bottom surface 117 of the motor housing 111 and a top surface 118 of the motor housing 111. FIG. 7 illustrates some of these example configurations.

Returning to the configuration illustrated in FIG. 6, the light source 112 is a dynamic light source, meaning that the light source 112 is configured to move relative to the portion of the support structure 101 where the light source 112 is located to redirect light emitted by the light source 112. Hence, for example, in configurations the dynamic light source 112 is configured to spin relative to the portion of the support structure 101 where the light source 112 is located. Hence, if the light source 112 is on a support leg 104, then the dynamic light source 112 is configured to spin relative to the support leg 104. As another example, in configurations the dynamic light source 112 is configured to pivot relative to the portion of the support structure 101 where the light source 112 is located. Hence, if the light source 112 is on the motor housing 111, then the dynamic light source 112 is configured to pivot relative to the motor housing 111. As still another example, in configurations the dynamic light source 112 is configured to both spin and pivot relative to the portion of the support structure 101 where the light source 112 is located. Hence, if the light source 112 is on the backboard 105, then the dynamic light source 112 is configured to spin and pivot relative to the backboard 105. The pivoting and spinning may be allowed by, as illustrated in FIG. 6, the dynamic light source 112 being mounted to the support structure 101 through a motor-driven ball joint 115, although other structures and techniques could also be used to cause the projected light to move.

Movement of the dynamic light source 112 may be controlled by a processor within the light source 112 or elsewhere on or in the support structure 101. With reference to FIG. 6, the processor may be within the base 116 of the ball joint 115.

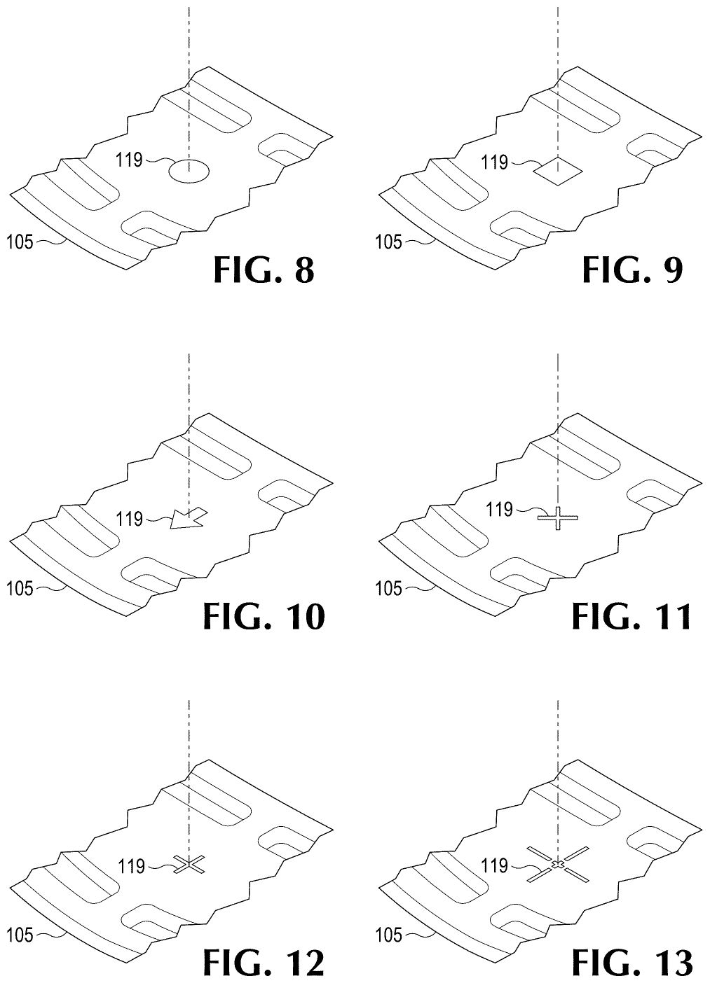

In configurations, the light source 112 is configured to project light emitted by the light source 112 into a geometric shape. FIGS. 8-13 illustrate examples of light patterns 119 that may be produced by a light source 112 in configurations of the disclosed technology. Those patterns include, but are not limited to, a circle (an example of which is illustrated in FIG. 8) or semicircle, a square (an example of which is illustrated in FIG. 9), an arrow (an example of which is illustrated in FIG. 10), an X (an example of which is illustrated in FIG. 11), a cross (an example of which is illustrated in FIG. 12), and crosshairs (an example of which is illustrated in FIG. 13). The light patterns, such as those illustrated in FIGS. 8-13, may be created by rapid movement (that is, spinning or pivoting, or both) of a dynamic light source 112. Additionally, light patterns such as those illustrated in FIGS. 8-13 may be created by a screen (also known as a gobo) at the light source 112 to cause the light source 112 to project the particular shape, whether the light source 112 is a dynamic light source 112 or not. Other techniques could also be used.

In configurations, the light source 112 is configured to project light emitted by the light source 112 onto the backboard 105, such as shown in FIGS. 8-13. In other configurations, the light source 112 is configured to project light emitted by the light source 112 onto the patient 103, onto the bellows 106, or onto the suction cup 108. In configurations, the light source 112 may include a focusing mechanism to manually or automatically focus a projected light pattern onto the desired target object, such as the patient 103, the backboard 105, or another part of the mechanical CPR device 100. The autofocusing system may be, for example, analogous to what is used in an autofocus camera, namely one or more sensors, a processor, and a motor or other device for adjusting one or more lenses between the light source 112 and the desired target object.

As noted above, aspects or features of the light may convey information to the user-rescuer. For instance, in configurations the colors or wavelengths emitted by the light source 112 may convey information. For example, the color red may convey danger or a warning and may be used in conjunction with an alarm, while the color green may convey that everything is in order for CPR compressions to begin or continue. As another example, the color blue may indicate when to ventilate the patient 103. In additional examples, the color yellow may be used to convey that the rescuer must perform an action, such as adjusting the suction cup. A particular color could also indicate that a defibrillator shock is about to occur or that the patient 103 is in ventricular fibrillation and might benefit from a defibrillator shock, as other examples, or a particular color may indicate when to recharge or replace the battery of the mechanical CPR device 100.

In configurations, the pattern of the pulsing from a stroboscopic light source 112 may convey information to the user-rescuer. For example, the pattern may be a message in a code that is known to the user-rescuer (through, for example, prior training), including, as an example, Morse code. As another example, the pulses of light may occur at a particular frequency, such as the frequency of chest compressions. As still another example, the color of the light or the pattern of the pulsing from a stroboscopic light source 112 could indicate the patient's pulse, including whether there has been a return of spontaneous circulation. As yet another example, the color of the light or the pattern of the pulsing from a stroboscopic light source 112 could indicate that the mechanical CPR device 100 is connected, whether through a cable or wirelessly, to another device, such as a defibrillator.

As another example, blacklight could be used to convey information to the user-rescuer about the presence of biological materials, such as blood, on the patient 103 or in the area of the mechanical CPR device 100. Blacklight could be used to convey information to the user-rescuer about the authenticity of accessories for the mechanical CPR device 100 by, for example, illuminating markings on the accessory that are visible under blacklight. Such accessories may include, as examples, a suction cup, an extension for a suction cup, a compression interface, a compression pad, an electronic circuit, a radio-frequency identification (RFID) tag, and an accelerometer.

In configurations, the light pattern emitted may guide the user-rescuer by, for example, drawing attention to the proper compression point for the application of chest compressions. In such configurations, for example, a dynamic light source 112 might project a moving shape, such as a circle, to the desired compression point on the chest of the patient 103 and, once there, the projected shape might flash. As another example, two dynamic light sources 112 might each project a semicircle, which move and converge to form a circle at the desired compression point on the chest of the patient 103. Thus, the dynamic light pattern that is projected might convey direction and urgency better than would a fixed light pattern. Such a feature might, therefore, make it easier for a user to learn to use the mechanical CPR device 100. Even in configurations without a dynamic light source 112, the pattern projected by the light source 112, or that results after light from the light source 112 is altered by having passed through the bellows 106 or the suction cup 108, may provide information to the user such as by providing an aiming target on the chest of the patient 103 or on the backboard 105. The aiming target could be, as examples, any of the light patterns 119 illustrated in FIGS. 8-13.

In configurations, there may be reflective material on the chest of the patient 103 that, together with light emitted by the light source 112, may convey information such as the position or size of the patient 103, including if the patient 103 is not properly aligned with the mechanical CPR device 100 or if the patient 103 is too large or too small for the mechanical CPR device 100. The reflective material may be, for example, a sticker. In configurations, there may be reflective material on the backboard 105 that, together with light emitted by the light source 112, may convey information such as that the backboard 105 is in place.

In configurations, the light pattern may function as a timer. In such configurations, for example, the substantially translucent bellows 106 may be illuminated sequentially from top to bottom (or from bottom to top) to visually represent to the user-rescuer the duration of a timer. In other configurations, the timer may be indicated by multiple light sources 112, such as LEDs, positioned in a circle. As the timer proceeds, lights around the circle are sequentially illuminated (or, alternatively, extinguished or have their color changed) to show the passage of time.

In configurations, the support structure 101 may include photoluminescent markings, visual markings, or both to aid with the features and benefits noted above.

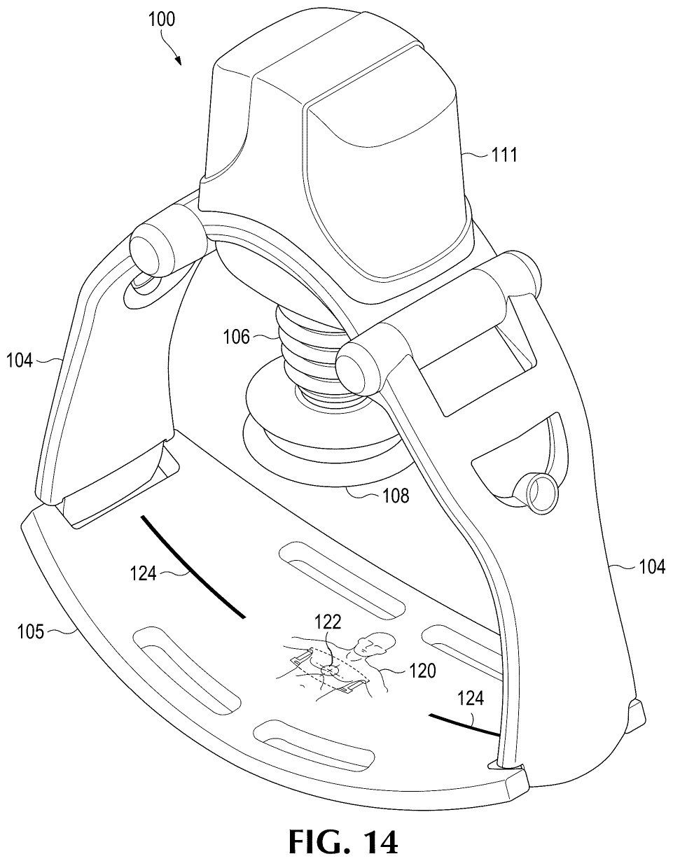

For instance, FIG. 14 illustrates a mechanical CPR device 100 having visual markings 120, according to example configurations. Features of mechanical CPR device 100 are the same or similar to those just described with regard to example configurations shown in FIGS. 1-13. That is, mechanical CPR device 100 includes a light source (not illustrated in FIG. 14) to providing lighting to aid the rescuer by illuminating the patient or portions of the mechanical CPR device, according to any of the uses and benefits of the light source described herein. As shown, mechanical CPR device 100 has visual markings 120, which, in configurations such as the example shown in FIG. 14, mark the backboard 105 with an illustration of a generic patient's torso over an illustrated backboard. Visual markings 120 specifically illustrate the generic patient's torso in an optimal position on the backboard, to aid a rescuer in aligning a patient on backboard 105 itself.

Visual markings 120, in configurations, further illustrate an optimal compression target 122 on the torso of the illustrated patient, positioned along a hypothetical inter-nipple line across the torso. The hypothetical inter-nipple line on the illustrated patient aligns with a central axis of backboard 105, and optimal compression target 122 indicates a center of the hypothetical inter-nipple line. Optimal compression target 122 accordingly indicates a point on a patient's torso ideal for applying compressions with mechanical CPR device 100, centered beneath the piston. To aid a rescuer in aligning a patient on the backboard 105, guiding lines 124 are also marked on backboard 105, in configurations. Specifically, guiding lines 124 are marked on a central axis along the length of backboard 105, aligned with the illustrated inter-nipple line of visual markings 120. In this way, a rescuer positioning a patient on backboard 105 can view guiding lines 124 and align guiding lines 124 with an imagined inter-nipple line on the patient's torso.

In configurations, suction cup 108 is formed of a transparent or semi-transparent material. As a result, a portion of the piston on which suction cup 108 is attached is visible through suction cup 108. For instance, although not shown in FIG. 14, configurations of mechanical CPR device 100 have a compression pad at an end of the piston, and suction cup 108 is removably attachable to the compression pad. In configurations having a compression pad and a transparent or semi-transparent, removably attachable suction cup 108, compression pad is visible through suction cup 108. The visibility of compression pad can be utilized, in example configurations, to further aid in aligning the patient's torso on backboard 105. In particular, a rescuer can imagine the patient's inter-nipple line using guiding lines 124 and position the compression pad, visible through suction cup 108, on a center of the imagined inter-nipple line—the center of the imagined inter-nipple line being the optimal compression point, as depicted with visual markings 120 and optimal compression target 122. In configurations, the compression pad is a particular color, chosen to aid the described alignment of the patient's torso on backboard 105.

In some configurations, visual markings 120 are used in conjunction with features of the example light sources described herein. For example, as described above, a light source can create a desired pattern of light and shadow based on the position and number of translucent and non-translucent portions of bellows 106, as well as the location of the light source. Visual markings 120—and, in particular, optimal compression target 122—indicate to a rescuer where the pattern of light should be positioned on an imagined inter-nipple line in order to perform compressions in an optimal location. The rescuer viewing visual markings 120 can thus determine where to position the pattern of light cast by the light sources, and the rescuer can subsequently position the patient on backboard 105 and use guiding lines 124 to imagine the patient's inter-nipple line and center the pattern of light appropriately. In additional or alternative configurations, as described with regard to FIGS. 8-13, the light source is configured to project light into a geometric shape onto backboard 105 or onto the chest of the patient. Accordingly, a rescuer viewing visual markings 120 can determine that the projected geometric shape is to be positioned on a center of an imagined inter-nipple line, just as optimal compression target 122 is positioned, and the rescuer can use guiding lines 124 to imagine that inter-nipple line and center the projected geometric shape on that inter-nipple line when positioning the patient.

In additional or alternative configurations, visual markings 120 and guiding lines 124 are also illuminated. That is, in some configurations, light sources are included in backboard 105 to aid the rescuer in seeing visual markings 120 and guiding lines 124 to fully utilize their alignment benefits, even in a dark environment.

In implementation, described aspects or features of the light source can thus be used in conjunction with other features of the mechanical CPR device to aid a rescuer in aligning a patient's torso within the mechanical CPR device, and more particularly, to quickly position the patient's torso such that compressions are performed at an optimal location. Use of the light source in conjunction with visual markings on the CPR device, in particular, thus improves a rescuer's accuracy finding the optimal location, as well as the rescuer's speed in positioning the patient to receive CPR compressions.

While FIGS. 1-4, 6, 7, and 14 illustrate a particular type of mechanical CPR device, configurations described in this disclosure are not limited to this particular type of mechanical CPR device. Rather, the disclosed technology may be applied to other types of mechanical CPR device, too. In addition, some configurations are not limited to being implemented only on a mechanical CPR device. For example, some configurations may be applied to any reciprocating piston that extends through a translucent bellows, where a light source illuminates the interior of the translucent bellows. As another example, some configurations may be applied to any reciprocating piston that has a translucent suction cup at an end of the piston, where a light source illuminates the interior of the translucent suction cup.

Accordingly, configurations of the disclosed technology provide lighting to aid the rescuer to properly see the patient 103 and the mechanical CPR device 100 in a dark environment by illuminating the patient 103 or portions of the mechanical CPR device 100. Additionally, configurations of the disclosed technology provide lighting to aid the rescuer to properly position the patient 103 relative the mechanical CPR device 100 by, for example, casting a light pattern to show where the chest of the patient 103 should be positioned. Also, configurations of the disclosed technology provide lighting for the rescuer to receive warnings, alerts, and other information from the mechanical CPR device 100—whether through the color of the light, the position of the light emitted from the light source 112, the pattern of the light, including the pulsation pattern, or other features of the light source 112 as discussed in this disclosure.

### EXAMPLES

Illustrative examples of the disclosed technologies are provided below. A particular configuration of the technologies may include one or more, and any combination of, the examples described below.

Example 1 includes a device comprising: a translucent bellows; a piston extending through an interior of the translucent bellows; a driver coupled to the piston and configured to extend and retract the piston; a light source configured to illuminate the interior of the translucent bellows.

Example 2 includes the device of Example 1, in which the light source is a light-emitting diode (LED).

Example 3 includes the device of Example 2, in which the LED is configured to emit light of different colors at different times.

Example 4 includes the device of any of Examples 2-3, in which the LED is configured to emit blacklight.

Example 5 includes the device of any of Examples 1-4, in which the translucent bellows includes a fluorescent material.

Example 6 includes the device of any of Examples 1-5, in which the light source is a laser diode.

Example 7 includes the device of any of Examples 1-6, in which the light source is stroboscopic.

Example 8 includes the device of any of Examples 1-7, in which the light source is configured to gradually dim in intensity.

Example 9 includes the device of any of Examples 1-8, in which the light source is configured to gradually increase in intensity.

Example 10 includes the device of any of Examples 1-9, in which the light source is configured to cycle between gradually dimming in intensity and gradually increasing in intensity.

Example 11 includes the device of any of Examples 1-10, in which the light source is within the translucent bellows.

Example 12 includes the device of any of Examples 1-11, further comprising a fiberoptic conduit configured to convey light emitted by the light source to the interior of the translucent bellows.

Example 13 includes the device of any of Examples 1-12, further comprising a photocell to measure an amount of ambient light, the photocell configured to generate a photocell signal based on a measured amount of ambient light, the light source being further configured to adjust an intensity of light emitted by the light source in response to the photocell signal.

Example 14 includes a mechanical cardiopulmonary resuscitation (“CPR”) device comprising: a compression mechanism configured to perform successive CPR compressions to a chest of a patient, the compression mechanism comprising: a translucent bellows, a piston extending through an interior of the translucent bellows, and a driver coupled to the piston and configured to extend the piston toward the chest of the patient and retract the piston away from the chest of the patient; a support structure configured to position the compression mechanism over the chest of the patient; and a light source configured to illuminate the interior of the translucent bellows.

Example 15 includes the mechanical CPR device of Example 14, in which the support structure comprises: a backboard configured to be placed underneath the patient; and a support leg configured to support the chest compression mechanism at a distance from the backboard.

Example 16 includes the mechanical CPR device of any of Examples 14-15, in which the light source is a light-emitting diode (LED).

Example 17 includes the mechanical CPR device of Example 16, in which the LED is configured to emit light of different colors at different times.

Example 18 includes the mechanical CPR device of any of Examples 16-17, in which the LED is configured to emit blacklight.

Example 19 includes the mechanical CPR device of any of Examples 14-18, in which the translucent bellows includes a fluorescent material.

Example 20 includes the mechanical CPR device of any of Examples 14-19, in which the light source is a laser diode.

Example 21 includes the mechanical CPR device of any of Examples 14-20, in which the light source is stroboscopic.

Example 22 includes the mechanical CPR device of any of Examples 14-21, in which the light source is configured to gradually dim in intensity.

Example 23 includes the mechanical CPR device of any of Examples 14-22, in which the light source is configured to gradually increase in intensity.

Example 24 includes the mechanical CPR device of any of Examples 14-23, in which the light source is configured to cycle between gradually dimming in intensity and gradually increasing in intensity.

Example 25 includes the mechanical CPR device of any of Examples 17-24, in which the light source is within the translucent bellows.

Example 26 includes the mechanical CPR device of any of Examples 17-25, further comprising a fiberoptic conduit configured to convey light emitted by the light source to the interior of the translucent bellows.

Example 27 includes the mechanical CPR device of any of Examples 17-26, further comprising a photocell to measure an amount of ambient light, the photocell configured to generate a photocell signal based on a measured amount of ambient light, the light source being further configured to adjust an intensity of light emitted by the light source in response to the photocell signal.

Example 28 includes a mechanical cardiopulmonary resuscitation (“CPR”) device comprising: a compression mechanism configured to perform successive CPR compressions to a chest of a patient, the compression mechanism comprising: a bellows having a translucent portion and a non-translucent portion, a piston extending through an interior of the bellows, and a driver coupled to the piston and configured to extend the piston toward the chest of the patient and retract the piston away from the chest of the patient; a support structure configured to position the compression mechanism over the chest of the patient; and a light source configured to illuminate the translucent portion and the non-translucent portion of the bellows to cast a light pattern determined, at least in part, by the translucent portion and the non-translucent portion of the bellows.

Example 29 includes the mechanical CPR device of Example 28, in which the light source is a light-emitting diode (LED).

Example 30 includes the mechanical CPR device of Example 29, in which the LED is configured to emit light of different colors at different times.

Example 31 includes the mechanical CPR device of any of Examples 29-30, in which the LED is configured to emit blacklight.

Example 32 includes the mechanical CPR device of any of Examples 28-31, in which the bellows includes a fluorescent material.

Example 33 includes the mechanical CPR device of any of Examples 28-32, in which the light source is a laser diode.

Example 34 includes the mechanical CPR device of any of Examples 28-33, in which the light source is stroboscopic.

Example 35 includes the mechanical CPR device of any of Examples 28-34, in which the light source is configured to gradually dim in intensity.

Example 36 includes the mechanical CPR device of any of Examples 28-35, in which the light source is configured to gradually increase in intensity.

Example 37 includes the mechanical CPR device of any of Examples 28-36, in which the light source is configured to cycle between gradually dimming in intensity and gradually increasing in intensity.

Example 38 includes the mechanical CPR device of any of Examples 31-37, in which the light source is within the bellows.

Example 39 includes the mechanical CPR device of any of Examples 31-37, in which the light source is on the support structure, external to the bellows.

Example 40 includes the mechanical CPR device of any of Examples 31-39, further comprising a fiberoptic conduit configured to convey light emitted by the light source to the interior of the bellows.

Example 41 includes the mechanical CPR device of any of Examples 31-40, further comprising a photocell to measure an amount of ambient light, the photocell configured to generate a photocell signal based on a measured amount of ambient light, the light source being further configured to adjust an intensity of light emitted by the light source in response to the photocell signal.

Example 42 includes the mechanical CPR device of any of Examples 31-41, in which the support structure comprises: a backboard configured to be placed underneath the patient; and a support leg configured to support the chest compression mechanism at a distance from the backboard.

Example 43 includes the mechanical CPR device of Example 42, in which the light source is on the support structure, external to the bellows, and the light source is further configured to cast the light pattern onto the backboard or onto the patient positioned on the backboard.

Example 44 includes a mechanical cardiopulmonary resuscitation (“CPR”) device comprising: a compression mechanism configured to perform successive CPR compressions to a chest of a patient; a support structure comprising a backboard configured to be placed underneath the patient, and a support leg configured to support the chest compression mechanism at a distance from the backboard; a dynamic light source on a portion of the support structure, the dynamic light source being configured to move relative to the portion of the support structure to redirect light emitted by the light source.

Example 45 includes the mechanical CPR device of Example 44, in which the dynamic light source is configured to spin relative to the portion of the support structure.

Example 46 includes the mechanical CPR device of Example 44, in which the dynamic light source is configured to pivot relative to the portion of the support structure.

Example 47 includes the mechanical CPR device of Example 44, in which the dynamic light source is configured to spin and to pivot relative to the portion of the support structure.

Example 48 includes the mechanical CPR device of any of Examples 44-47, in which the dynamic light source is stroboscopic.

Example 49 includes the mechanical CPR device of any of Examples 44-48, in which the light source is configured to gradually dim in intensity.

Example 50 includes the mechanical CPR device of any of Examples 44-49, in which the light source is configured to gradually increase in intensity.

Example 51 includes the mechanical CPR device of any of Examples 44-50, in which the light source is configured to cycle between gradually dimming in intensity and gradually increasing in intensity.

Example 52 includes the mechanical CPR device of any of Examples 47-51, in which the dynamic light source is configured to emit blacklight.

Example 53 includes the mechanical CPR device of any of Examples 47-52, in which the dynamic light source is a light-emitting diode (LED).

Example 54 includes the mechanical CPR device of Example 53, in which the LED is configured to emit light of different colors at different times.

Example 55 includes the mechanical CPR device of any of Examples 47-53, in which the dynamic light source is a laser diode.

Example 56 includes the mechanical CPR device of any of Examples 47-55, further comprising a photocell to measure an amount of ambient light, the photocell configured to generate a photocell signal based on a measured amount of ambient light, the dynamic light source being further configured to adjust an intensity of light emitted by the dynamic light source in response to the photocell signal.

Example 57 includes the mechanical CPR device of any of Examples 47-56, in which the dynamic light source is configured to project light emitted by the dynamic light source into a geometric shape.

Example 58 includes the mechanical CPR device of Example 57, in which the geometric shape is selected from the group consisting of a circle, a cross, an X, an arrow, a square, and crosshairs.

Example 59 includes the mechanical CPR device of any of Examples 47-58, in which the dynamic light source is configured to project light emitted by the dynamic light source onto the backboard of the support structure.

Example 60 includes the mechanical CPR device of any of Examples 47-59, in which the dynamic light source is configured to project light emitted by the dynamic light source onto the patient.

Example 61 includes the mechanical CPR device of any of Examples 47-60, the compression mechanism comprising a piston extending through an interior of a bellows, in which the dynamic light source is configured to project light emitted by the dynamic light source onto the bellows.

Example 62 includes the mechanical CPR device of any of Examples 47-61, in which the portion of the support structure is the support leg.

Example 63 includes the mechanical CPR device of any of Examples 47-61, in which the portion of the support structure is a motor housing supported by the support leg at a distance from the backboard.

Example 64 includes a mechanical cardiopulmonary resuscitation (“CPR”) device comprising: a compression mechanism configured to perform successive CPR compressions to a chest of a patient, the compression mechanism comprising: a piston, a translucent suction cup secured to an end of the piston, and a driver coupled to the piston and configured to extend the piston toward the chest of the patient and retract the piston away from the chest of the patient; a support structure configured to position the compression mechanism over the chest of the patient; and a light source configured to illuminate the translucent suction cup.

Example 65 includes the mechanical CPR device of Example 64, in which the light source is on the support structure.

Example 66 includes the mechanical CPR device of any of Examples 64-65, in which the support structure comprises: a backboard configured to be placed underneath the patient; and a support leg configured to support the chest compression mechanism at a distance from the backboard.

Example 67 includes the mechanical CPR device of any of Examples 64-66, in which the light source is a light-emitting diode (LED).

Example 68 includes the mechanical CPR device of Example 67, in which the LED is configured to emit light of different colors at different times.

Example 69 includes the mechanical CPR device of any of Examples 67-68, in which the LED is configured to emit blacklight.

Example 70 includes the mechanical CPR device of any of Examples 64-69, in which the translucent suction cup includes a fluorescent material.

Example 71 includes the mechanical CPR device of any of Examples 64-70, in which the light source is a laser diode.

Example 72 includes the mechanical CPR device of any of Examples 64-71, in which the light source is stroboscopic.

Example 73 includes the mechanical CPR device of any of Examples 64-72, in which the light source is configured to gradually dim in intensity.

Example 74 includes the mechanical CPR device of any of Examples 64-73, in which the light source is configured to gradually increase in intensity.

Example 75 includes the mechanical CPR device of any of Examples 64-73, in which the light source is configured to cycle between gradually dimming in intensity and gradually increasing in intensity.

Example 76 includes the mechanical CPR device of any of Examples 67 or 69-75, in which the light source is within the translucent suction cup.

Example 77 includes the mechanical CPR device of any of Examples 67-76, further comprising a fiberoptic conduit configured to convey light emitted by the light source to an interior of the translucent suction cup.

Example 78 includes the mechanical CPR device of any of Examples 67-77, further comprising a photocell to measure an amount of ambient light, the photocell configured to generate a photocell signal based on a measured amount of ambient light, the light source being further configured to adjust an intensity of light emitted by the light source in response to the photocell signal.

The contents of the present document have been presented for purposes of illustration and description, but such contents are not intended to be exhaustive or limited to the disclosure in the form disclosed. Many modifications and variations will be apparent to those of ordinary skill in the art without departing from the scope and spirit of the disclosure. The aspects of the disclosure in this document were chosen and described to explain the principles of the disclosure and the practical application, and to enable others of ordinary skill in the art to understand the disclosure with various modifications as are suited to the particular use contemplated.

Accordingly, it is to be understood that the disclosure in this specification includes all possible combinations of the particular features referred to in this specification. For example, where a particular feature is disclosed in the context of a particular example configuration, that feature can also be used, to the extent possible, in the context of other example configurations.

Additionally, the described versions of the disclosed subject matter have many advantages that were either described or would be apparent to a person of ordinary skill. Even so, all of these advantages or features are not required in all versions of the disclosed apparatus, systems, or methods.

Also, when reference is made in this application to a method having two or more defined steps or operations, the defined steps or operations can be carried out in any order or simultaneously, unless the context excludes those possibilities.

The terminology used in this specification is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof. Hence, for example, an article “comprising” or “which comprises” components A, B, and C can contain only components A, B, and C, or it can contain components A, B, and C along with one or more other components.

It is understood that the present subject matter may be embodied in many different forms and should not be construed as being limited to the example configurations set forth in this specification. Rather, these example configurations are provided so that this subject matter will be thorough and complete and will convey the disclosure to those skilled in the art. Indeed, the subject matter is intended to cover alternatives, modifications, and equivalents of these example configurations, which are included within the scope and spirit of the subject matter set forth in this disclosure. Furthermore, in the detailed description of the present subject matter, specific details are set forth to provide a thorough understanding of the present subject matter. It will be clear to those of ordinary skill in the art, however, that the present subject matter may be practiced without such specific details.

We claim:

1. A mechanical cardiopulmonary resuscitation (“CPR”) device comprising:
a compression mechanism configured to perform successive CPR compressions to a chest of a patient, the compression mechanism comprising:
a piston,
a translucent suction cup secured to an end of the piston, and
a driver coupled to the piston and configured to extend the piston toward the chest of the patient and retract the piston away from the chest of the patient;
a support structure configured to position the compression mechanism over the chest of the patient; and
a light source configured to illuminate the translucent suction cup.

2. The mechanical CPR device of claim 1, in which the light source is on the support structure.

3. The mechanical CPR device of claim 1, in which the support structure comprises:
a backboard configured to be placed underneath the patient; and
a support leg configured to support the chest compression mechanism at a distance from the backboard.

4. The mechanical CPR device of claim 1, in which the light source is a light-emitting diode (LED).

5. The mechanical CPR device of claim 4, in which the LED is configured to emit light of different colors at different times.

6. The mechanical CPR device of claim 4, in which the LED is configured to emit blacklight.

7. The mechanical CPR device of claim 6, in which the translucent suction cup includes a fluorescent material.

8. The mechanical CPR device of claim 1, in which the light source is a laser diode.

9. The mechanical CPR device of claim 1, in which the light source is stroboscopic.

10. The mechanical CPR device of claim 1, in which the light source is configured to gradually dim in intensity.

11. The mechanical CPR device of claim 1, in which the light source is configured to gradually increase in intensity.

12. The mechanical CPR device of claim 1, in which the light source is configured to cycle between gradually dimming in intensity and gradually increasing in intensity.

13. The mechanical CPR device of claim 1, in which the light source is within the translucent suction cup.

14. The mechanical CPR device of claim 1, further comprising a fiberoptic conduit configured to convey light emitted by the light source to an interior of the translucent suction cup.

15. The mechanical CPR device of claim 1, further comprising a photocell to measure an amount of ambient light, the photocell configured to generate a photocell signal based on a measured amount of ambient light, the light source being further configured to adjust an intensity of light emitted by the light source in response to the photocell signal.
